(19) United States
(12) Patent Application Publication
(10) Pub. No.: US 2008/0167735 A1
(43) Pub. Date: Jul. 10, 2008

(54) Repetitive controller to compensate for (61±1) harmonics

(76) Inventors: Gerardo Escobar Valderrama, San Luis Potosi (MX); Perla G. Hernandez Briones, San Luis Potosi (MX); Panfilo R. Martinez Rodriguez, San Luis Potosi (MX); Romeo Ortega Martinez, Orsay (FR)

Correspondence Address: DEFILLO & ASSOCIATES, INC., P.O. Box 14104, Clearwater, FL, 33766, US

(21) Appl. No.: 11/650,638

(22) Filed: Jan. 8, 2007

(51) Int. Cl. G05B 13/04

(52) U.S. Cl. 700/45

(57) ABSTRACT

A repetitive controller scheme with two feedbacks one negative and one positive plus a negative feedforward introduces infinitely many poles on the imaginary axis located at j(6l±1)ωₒ (l=0,1,2, . . . ,∞) which produces resonant peaks tuned at 6l±1 (l=0,1,2, . . . ,∞) multiples of the fundamental frequency ωₒ. The feedforward introduces zeros, which produce notches located at 3lωₒ (l=0,1,2, . . . ,∞), that is, in between two consecutive resonance peaks. The latter has the advantage of making the controllers more selective, in the sense that the original overlapping (appearing at the valleys) or interaction between consecutive resonant peaks is removed by the notches. This would allow, in principle, peaks of higher gains and slightly wider bandwidth, avoiding, at the same time, the excitation of harmonics located in between two consecutive peaks. The proposed compensator composed of a negative and a positive feedback plus feedforward is especially useful when only the compensation of 6l±1 (l=0,1,2, . . . ,∞) harmonics is required, but not all harmonics, like in many power electronic systems. In contrast, the positive feedback controller or the negative feedback controller would try to reinject, and indeed amplify, any small noise, which has components on the even frequencies or frequencies 3(2l+1)ωₒ (l=0,1,2, . . . ,∞).

### FIELD OF THE INVENTION

The present invention concerns a scheme that is aimed or the compensation of harmonic 6l±1 (l=0,1,2, . . . ,∞) multiples of the fundamental frequency. These components are of special interest in industry applications due to the predominant loads.

### BACKGROUND OF THE INVENTION

In power electronics applications as well as in many communication applications the tracking or rejection of periodic signals is an issue that commonly arises. In the power electronics literature, several controllers based on these ideas have been applied to switching power supplies, AC/DC converters, motor speed fluctuation, synchronous rectifiers, uninterruptible power supplies (UPS) and active filters. In these cases, the disturbances and/or reference signals are assumed periodic, and thus, they can be described as the sum of specific higher harmonics of the fundamental frequency of the power source. Hence the compensation issue above described is addressed also as the harmonic (distortion) compensation issue.

Depending on the application there are specific harmonic components to consider, for instance it is well known that the even harmonic components do not appear regularly in a power system, and that the most commonly found are the odd harmonics.

Moreover, it has been observed that among the odd harmonic components, there has been a special interest in industry for the compensation of harmonics multiples 6l±1 (l=0,1,2, . . . ,∞) of the fundamental frequency, which is due to the fact that many processes involve the use of six pulse converters which produce harmonic components at those frequencies. Among the different compensation schemes, repetitive control arises as a simple and practical solution for the harmonic compensation issue providing exact asymptotic output tracking of periodic inputs or rejection of periodic disturbances, and is based on the internal model principle. The internal model principle states that the controlled output can track a class of reference commands without a steady state error if the generator, or the model, for the reference is included in the stable closed-loop system. Therefore, according to the internal model principle, if a periodic disturbance has an infinite Fourier series (of harmonic components), then an infinite number of resonant filters are required to reject the disturbance.

For a detailed description of internal model principle, reference is made to B. Francis and W. Wonham, “The internal model principle for linear multivariable regulators,” Applied Mathematics and Optimization, Vol. 2, pp. 170-194, 1975, which is incorporated by reference. For a description of a stability study of linear infinite dimensional repetitive controllers, reference is made to S. Hara, Y. Yamamoto, T. Omata and M. Nakano, “Repetitive control systems: A new type servo systems and its applications,” IEEE Trans. Automat. Contr., Vol. 33, No. 7, pp. 659-667, 1988 and the numerous references therein.

The idea behind the repetitive control approach is that, a simple delay line in a proper feedback array can be used to produce an infinite number of poles and thereby simulate a bank of an infinite number of resonant filters, leading to system dynamics of infinite dimension. Repetitive control may have many applications on power electronic systems as it may offer some advantages over conventional solutions particularly in rectifiers, inverters and active filters. The use of repetitive control for a reduction of periodic disturbances with frequencies corresponding to the specific frequencies is disclosed in U.S. Pat. No. 5,740,090, where the transfer function of the controller includes an infinite number of poles, with no zeros introduced between the poles.

### SUMMARY OF THE INVENTION

As above mentioned, depending on the application, there may be interest in the compensation of a selected group of harmonic components. In particular, this patent presents a scheme that is aimed for the compensation of harmonic 6l±1 (l=0,1,2, . . . ,∞) multiples of the fundamental frequency. These components are of special interest in industry applications due to the predominant loads.

Earlier applications of repetitive control were based on the positive feedback scheme, such as by placing a delay line in the direct path and others in the feedback path. It is important to note that a positive feedback structure may have the disadvantage of compensating for every harmonic, including odd and even harmonics and the dc component, if any. Moreover, depending on the position of the delay line in the structure, the delay line may even modify the phase shift, which may result in a need for some extra filters to alleviate this problem.

The use of repetitive control for compensation of all harmonics with frequencies corresponding to the specific frequencies is disclosed in co-pending U.S. application Ser. No. 11/217,682, which was filed on Sep. 2, 2005, is titled “REPETITIVE CONTROLLER FOR COMPENSATION OF PERIODIC SIGNALS”, and is incorporated by reference. In this application, a repetitive controller scheme with positive feedback and feedforward introduces infinitely many poles on the imaginary axis located at both even and odd harmonics (including a pole in the origin) and zeros between the poles.

Later, a repetitive scheme based on a negative feedback approach with feedforward was introduced. The negative based repetitive scheme, in contrast to the positive feedback approach, was aimed to compensate only for the odd harmonics, and thereby reducing the possibility of reinjecting unnecessary distortion into the system.

The use of repetitive control for compensation of odd harmonics with frequencies corresponding to the specific frequencies is disclosed in co-pending U.S. application Ser. No. 11/217,682, which was filed on Sep. 22, 2005, is titled “REPETITIVE CONTROLLER TO COMPENSATE FOR ODD HARMONICS”, and is incorporated by reference. In this application, a repetitive controller scheme with negative feedback and feedforward introduces infinitely many poles on the imaginary axis located at odd harmonics and zeros between the poles, i.e., at even harmonics. Preliminary versions that did not include the feedforward path appeared also in journals. See for instance J. Leyva-Ramos, G. Escobar, P. R. Martinez and P. Mattavelli. “Analog Circuits to Implement Repetitive Controllers for Tracking and Disturbance Rejection of Periodic Signals,” IEEE Transactions on Circuits and Systems II: Express Briefs.

Vol. 52, Issue 8, August 2005, pp. 466-470; and, G. Escobar, J. Leyva-Ramos, P. R. Martínez and P. Mattavelli, “A negative feedback repetitive control scheme for harmonic compensation,” IEEE Trans. on Industrial Electronics (Letters to the Editor).

Vol. 53, Issue 4, June 2006, pp. 1383-1386. A preliminary version including the feedforward modification appeared in G. Escobar, J. Leyva-Ramos and P. R. Martínez. “Analog Circuits to Implement Repetitive Controllers with Feedforward for Harmonic Compensation,” IEEE Trans. on Industrial Electronics, Vol. 53, No. 6, December 2006, pp. 1-7.

Several applications of these controllers have been reported in journals by G. Escobar, J. Leyva-Ramos, P. R. Martínez and A. A. Valdez in “A repetitive-based controller for the boost converter to compensate the harmonic distortion of the output voltage,” IEEE Trans. on Control Systems Technology, Vol. 13, No. 3, May 2005. pp. 500-508, where a positive feedback compensator plus feedforward was used to ameliorate the audio-susceptibility response of a boost converter.

Moreover, the negative feedback plus feedforward compensator was used in G. Escobar, A. A. Valdez, J. Leyva-Ramos and P. Mattavelli, “A Repetitive-based controller for UPS using a combined capacitor/load current sensing,” in Proc. 36th IEEE Power Electronics Specialist Conference PESC 2005, Recife, Brazil, Jun. 12-16, 2005, pp. 955-961, to guarantee an almost sinusoidal response of a three phase inverter, in spite of a distorting load. A very close work to the previous have been presented by Ramon Costa-Castelló and Robert Griñó in “A Repetitive Controller for Discrete-Time Passive Systems,” Automatica, Vol. 42, 2006, pp. 1605-1610.

Although both the positive and the negative feedback based schemes may apparently solve the harmonics compensation problem, they may lead to more distortion in certain cases. Consider, for instance, a system where even harmonics do not exist originally, nor triplet harmonics (multiples of 3 of the fundamental), but only the 6l±1 (l=0,1,2, . . . ,∞) harmonics appear, like for instance in a 6 pulse rectifier, which is a converter widely used in industry. In this case, both repetitive controllers would tend to amplify, and even reinject, any low level noise having harmonic components on the even and the triplet frequencies. This evidently has the danger of producing responses polluted with such harmonics which were not present before.

As described in more detail below, a repetitive scheme based on the feedback array of two delay lines plus a feedforward path is introduced to compensate for the 6l±1 (l=0,1,2, . . . ,∞) multiples of the fundamental frequency only, and thereby reducing the possibility of reinjecting unnecessary distortion into the system.

Experimental results of a setup implemented in the laboratory are also given. Both analog and digital implementations of the proposed scheme are possible. However, digital implementation has been preferred for its simplicity, which can reproduce the same frequency response as an infinite set of resonant filters tuned at higher 6l±1 (l=0,1,2, . . . ,∞) harmonic frequencies of the fundamental.

In one general aspect, this repetitive controller employs two feedback loops, a negative and a positive, plus a feedforward. This repetitive controller compensates only for the 6l±1 (l=0,1,2, . . . ,∞) harmonics, and thereby reduces the possibility of reinjecting unnecessary distortion into the system. The feedforward path considerably improves the frequency response and performance, and provides higher gains with enhanced selectivity.

This approach may be particularly useful, and may generate cleaner responses than traditional positive and negative feedback based repetitive schemes, in applications of power electronic systems containing mainly 6l±1 (l=0,1,2, . . . ,∞) harmonics. A description of the approach and corresponding experimental frequency and time domain responses are given.

Other forms, features, and aspects of the above-described methods and system are described in the detailed description that follows.

### BRIEF DESCRIPTION OF THE DRAWINGS

FIG. 1 is a block diagram of the proposed repetitive controller which includes positive and negative feedback loops plus a feedforward.

FIG. 2 shows the Nyquist plots of the proposed repetitive controller transfer function for different values of K.

FIG. 3 is a block diagram of practical modifications for the repetitive controller described herein.

FIG. 4 shows theoretical Bode plots of the repetitive controller for different values of K (0.95, 0.75 and 0.5). (top) Magnitude (y-axis dB, x-axis Hz), and (bottom) phase (y-axis deg, x-axis Hz).

FIG. 5 shows an experimental frequency response of the proposed repetitive controller (x-axis 125 Hz/div and y-axis 20 dB/div): (top) K=0.75, and (bottom) K=0.95.

FIG. 6 shows an experimental time response of the proposed compensator to a sinusoidal signal of frequency 60 Hz and amplitude 100 mV (x-axis 4 ms/div). (top) Input u(t) (y-axis 100 mV/div), and (bottom) output y(t) (y-axis 1 V/div).

FIG. 7 shows an experimental time response to a sinusoidal input signal of frequency 180 Hz and amplitude 1 V (x-axis 4 ms/div). (top) Input u(t) (y-axis 1 V/div), and (bottom) output y(t) (y-axis 500 mV/div).

### DETAILED DESCRIPTION OF THE INVENTION

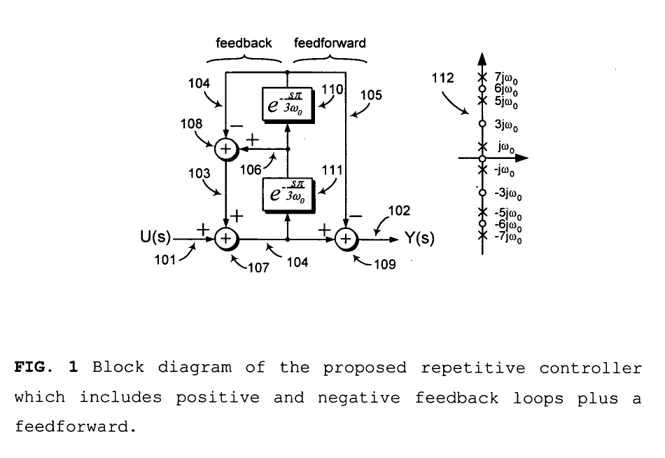

The block diagram of the proposed repetitive controller with negative feedback 104, positive feedback 103, and including the feedforward 105 is shown in FIG. 1. The resulting transfer function is:

$$G ( s ) = \frac{Y ( s )}{U ( s )} = \frac{1 - {e}^{- \frac{2 s π}{3 {ω}_{o}}}}{1 + {e}^{- \frac{2 s π}{3 {ω}_{o}}} - {e}^{- \frac{s π}{3 {ω}_{o}}}}$$

where U(s) 101 is the input, Y(s) 102 is the output, and ωₒ represents, throughout this document, the fundamental frequency of the periodic signal under compensation. An adder 107 outputs a signal 104, which is the addition of the input signal with the output coming out from the adder 108, this signal enters a block representing a delay line 111. The signal gotten from this delay block 106 enters another delay line 110 and the adder 108. Another adder 109 which outputs signal 102 is the addition of signal 105 with signal 104. Notice that, the delay lines are represented by blocks 110 and 111, with s being the Laplace operator, e being the basic value of the natural logarithm and the delay time being

$${τ}_{d} = \frac{π}{3 {ω}_{o}} .$$

The poles of the negative representation can be found from e^{-(s-jω}^{ₒ}^{)π/3ω}^{ₒ}=1 and e^{-(s+jω}^{ₒ}^{)π/3ω}^{ₒ}=1. Notice that, the complex numbers e^{-(s-jω}^{ₒ}^{)π/3ω}^{ₒ}|s=jω and e^{-(s+jω}^{ₒ}^{)π/3ω}^{ₒ}|s=jω equals 1 for ω=(6l±1)ωₒ for every l=0,1,2, . . . ,∞. As for the zeros e^{-2sπ/3ω}^{ₒ}|s=jω equals 1 for ω=3lωₒ, for every l=0,1,2, . . . ,∞. Due to the delay line, this transfer function has infinitely many poles on the imaginary axis 112. Notice that, with the introduction of the feedforward path, an infinite number of zeros also appear on the imaginary axis 112. The corresponding transfer functions for the compensator can also be written as:

$$G ( s ) = \frac{1 - {e}^{- \frac{2 s π}{3 {ω}_{o}}}}{1 + {e}^{- \frac{2 s π}{3 {ω}_{o}}} - {e}^{- \frac{s π}{3 {ω}_{o}}}} = \frac{{e}^{\frac{s π}{3 {ω}_{o}}} - {e}^{- \frac{s π}{3 {ω}_{o}}}}{{e}^{\frac{s π}{3 {ω}_{o}}} + {e}^{- \frac{s π}{3 {ω}_{o}}} - 1}$$

$$or equal to \begin{matrix}G ( s ) = \frac{2 sinh ( \frac{s π}{3 {ω}_{o}} )}{2 cosh ( \frac{s π}{3 {ω}_{o}} ) - 1} \\ = \frac{\frac{s π}{3 {ω}_{o}} {\prod }_{l = 1}^{∞} ( \frac{{s}^{2}}{{( 3 l )}^{2} {ω}_{o}^{2}} + 1 )}{{\prod }_{l = 1}^{∞} ( \frac{{s}^{2}}{{( 6 l + 1 )}^{2} {ω}_{o}^{2}} + 1 )}\end{matrix}$$

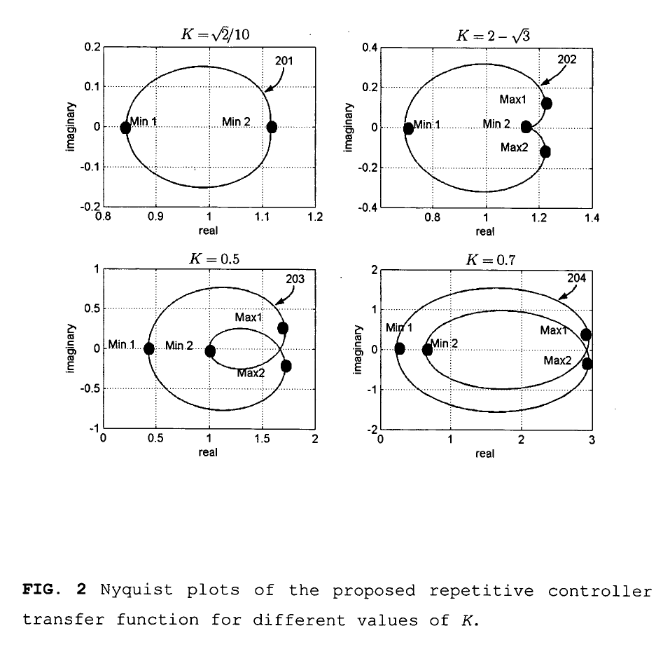

Notice that, the proposed compensator contains harmonic oscillators tuned only at harmonics (6l±1)ωₒ for every l=0,1,2, . . . ,∞. That is, for G(s), the poles are located at harmonics 6l±1 (l=0,1,2, . . . ,∞) of the fundamental frequency ωₒ, and there is no pole at the origin (see FIG. 2). Notice also that, each zero of G(s) lies exactly at the harmonics 3lωₒ for every l=0,1,2, . . . ,∞, that is, in the middle point between two consecutive poles including a zero in the origin (see FIG. 2).

Conversely, if the fundamental frequency is known, then the delay time is computed using

$${τ}_{d} = \frac{π}{3 {ω}_{o}} = \frac{1}{6 {f}_{o}} , where {ω}_{o} = 2 π {f}_{o} .$$

For instance, if compensation of harmonics of 60 Hz is required, taking fₒ=60 Hz, then the corresponding delay is τ_{d}=2.77 ms.

The above repetitive controller, however, may be unsuited for use in a real application. The expected Bode plots for the controller consist of a set of peaks centered at the harmonic frequencies (6l±1)ωₒ for every l=0,1,2, . . . ,∞. Moreover, thanks to the presence of the zeros, notches appear in the middle points between two consecutive peaks, that is, at 3lωₒ for every l=0,1,2, . . . ,∞.

The gain at the resonant frequencies is, in theory, infinite, while for the notches it goes to zero (minus infinite in dB); therefore, instability problems may arise. To alleviate this issue, damping is added to all the poles/zeros by slightly shifting them to the left of the imaginary axis. As a consequence of this simple pole/zero shifting process, the peaks' amplitude becomes bounded. This shifting process is realized as follows: \tilde{G}(s)=G(s+a).

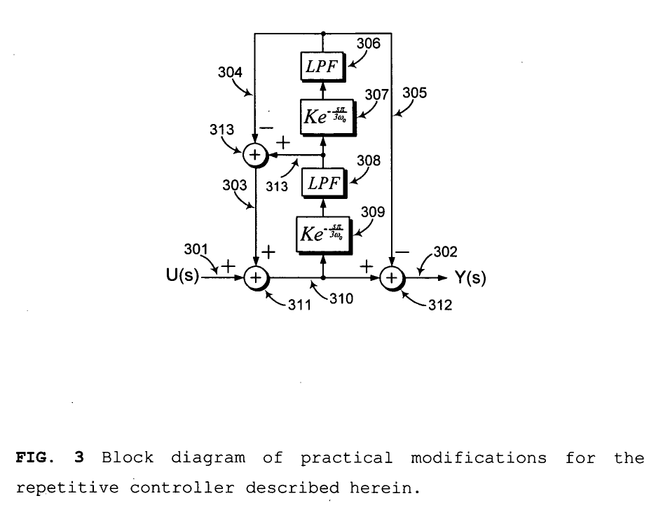

Applying the shifting to the exponential term results in e^{-(s+a)π/3ω}^{ₒ}=e^{-aπ/3ω}^{ₒ}e^{-sπ/3ω}^{ₒ}. Notice that, this is equivalent to multiply the exponential function by a gain factor K=e^{-aπ/3ω}^{ₒ} as shown in FIG. 3. Hence, by proposing a gain K>1 the poles/zeros move to the right, but if 0<K<1 then they move to the left. When gain K is introduced in the transfer function, three different situations arise depending on the values of K used. The Nyquist plot of \tilde{G}(s) is used to better distinguish these situations as shown in FIG. 2.

It was also observed that, the shape of the Nyquist plot of \tilde{G}(s) goes from a flattened circle 201 for

$$0 < K \leq \frac{\sqrt{2}}{10}$$

to a cardioid 202 for

$$\frac{\sqrt{2}}{10} < K \leq ( 2 - \sqrt{3} ) .$$

Then, for (2−\sqrt{3})<K<1 the Nyquist plot becomes a limaçon 203 that approaches a circle of arbitrarily large radium 204 as K gets closer to 1. It is clear that the range of interest lies in values of K slightly smaller than 1, i.e., when the Nyquist plot of \tilde{G}(s) corresponds to a limaçon. In this case, there are two maximum points M₁ and M₂ in 203, which correspond to the resonance peaks tuned at frequencies close to (6l−1)ωₒ and (6l+1)ωₒ for every l=0,1,2, . . . ,∞, respectively. Moreover, there are two minimums m₁ and m₂ tuned at 3(2l+1)ωₒ and 6lωₒ for every l=0,1,2, . . . ,∞, respectively. The gains of both resonance peaks M₁ and M₂ are the same and both maximum points differ only by a phase shift. It can be shown that the resonance peaks, originally of infinite magnitude, reach a maximum magnitude of

$$\sqrt{\frac{6 {K}^{2} + 2 \sqrt{3} \sqrt{1 + {K}^{4} + {K}^{8}}}{3 {( - 1 + {K}^{2} )}^{2}}} ,$$

with a phase shift of

$$θ = ∓ {tan}^{- 1} [ \frac{\begin{matrix}2 K ( 3 + 3 {K}^{4} - 2 \sqrt{3} \sqrt{1 + {K}^{4} + {K}^{8}} ) \\ \sqrt{1 - \frac{{( 2 + {K}^{2} + 2 {K}^{4} - \sqrt{3} \sqrt{1 + {K}^{4} + {K}^{8}} )}^{2}}{4 {( K + {K}^{3} )}^{2}}}\end{matrix}}{( - 1 + {K}^{2} ) ( 3 {K}^{2 +} \sqrt{3} \sqrt{1 + {K}^{4} + {K}^{8}} )} ] .$$

The resonance peaks occurs at

$$ω = {cos}^{- 1} ( \frac{2 + {K}^{2} + 2 {K}^{4} - \sqrt{3} \sqrt{1 + {K}^{4} + {K}^{8}}}{2 ( K + {K}^{3} )} ) \frac{3}{π} {ω}_{o} ,$$

which can be approximated using Taylor's series, around K=1, as

$$ω = ( 6 l \pm 1 ) {ω}_{o} \pm [ \frac{\sqrt{3}}{π} \frac{{( K - 1 )}^{2}}{2} ] {ω}_{o} ,$$

that is, there is a small difference given by

$$\frac{\sqrt{3}}{π} \frac{{( K - 1 )}^{2}}{2} {ω}_{o}$$

with respect to the expected frequencies (6l±1)ωₒ. Notice that, this difference tends to zero as K gets closer to 1.

The phase shift can be also approximated using Taylor's series, around K=1, as

$$θ = ∓ \frac{( K - 3 ) ( K - 1 )}{2 \sqrt{3}} ,$$

which also tends to zero as K gets closer to 1. The notches reach a minimum magnitude of

$$\frac{1 - {K}^{2}}{1 + K + {K}^{2}}$$

for m₁ and

$$\frac{1 - {K}^{2}}{1 - K + {K}^{2}}$$

for m₂, both of them with a zero phase shift. The magnitude, at the expected frequencies ω=(6l±1)ωₒ, is

$$\frac{\sqrt{{K}^{2} - K + 1}}{1 - K} ,$$

which is slightly smaller than the gain at the resonance peaks, with a phase shift given by

$$θ = \pm {tan}^{- 1} \frac{\sqrt{3} ( K - 1 ) K}{2 {K}^{3} + {K}^{2} + K + 2} .$$

It can be noticed that, without the feedforward path the maximum attainable gain at the resonance peaks is

$$\frac{2}{\sqrt{3}} \frac{1}{( 1 - {K}^{2} )}$$

that occurs at frequencies

$$ω = [ \frac{3 {cos}^{- 1} ( \frac{1 + {K}^{2}}{4 K} )}{π} ] {ω}_{o} .$$

The last can be approximated using Taylor's series around K=1 as

$$ω = ( 6 𝓁 \pm 1 ) {ω}_{o} ∓ [ \frac{\sqrt{3}}{π} \frac{{( K - 1 )}^{2}}{2} ] {ω}_{o}$$

for every l=0,1,2, . . . ,∞. Notice that, there is a small difference

$$\frac{\sqrt{3}}{π} \frac{{( K - 1 )}^{2}}{2} {ω}_{o}$$

with respect to the expected frequencies (6l±1)ωₒ which gets smaller as K gets closer to 1. The phase at these resonance peaks is given by

$$θ = \pm {tan}^{- 1} \frac{\sqrt{14 {K}^{2} - 1 - {K}^{4}}}{- 7 + {K}^{2}} .$$

Now, at ω=(6l±1)ωₒ (l=0,1,2, . . . ,∞) the gain (which is not the maximum) is given by

$$\frac{1}{( 1 - K ) \sqrt{1 + K + {K}^{2}}}$$

with a corresponding phase shift of

$$θ = \pm {tan}^{- 1} \frac{\sqrt{3} K}{2 + K} .$$

Moreover, it has been observed in this case that, there are valleys and no longer notches between every two consecutive peaks with minimum attainable gains given by

$$\frac{1}{1 + K + {K}^{2}} .$$

It is important to mention that when a gain K is introduced a small error is introduced as well between the expected ω=(6l±1)ωₒ (l=0,1,2 . . . ,∞) and the exact o at which the resonance peaks occur.

It is also recommended, in repetitive control schemes, to include a simple Low Pass Filter (LPF) as shown in FIG. 3 where U(s) 301 is the input, Y(s) 302 is the output. An adder 311 outputs a signal 310, which is the addition of the input signal with the feedback 303. Another adder 313 outputs a signal, which is the addition of the feedback 304, and the output signal 313 of the LPF 308. The third adder 312 is the addition of the feedforward 305 and the output signal of the adder 310. Notice that, block 307 and 309 contain the delay line and the gain K, and blocks 306 and 308 represent the LPFs. As before, ωₒ represents the fundamental frequency of the periodic signal under compensation. This modification restricts the bandwidth of the controller, and at the same time reinforces the stability when the controller is inserted in a closed-loop system.

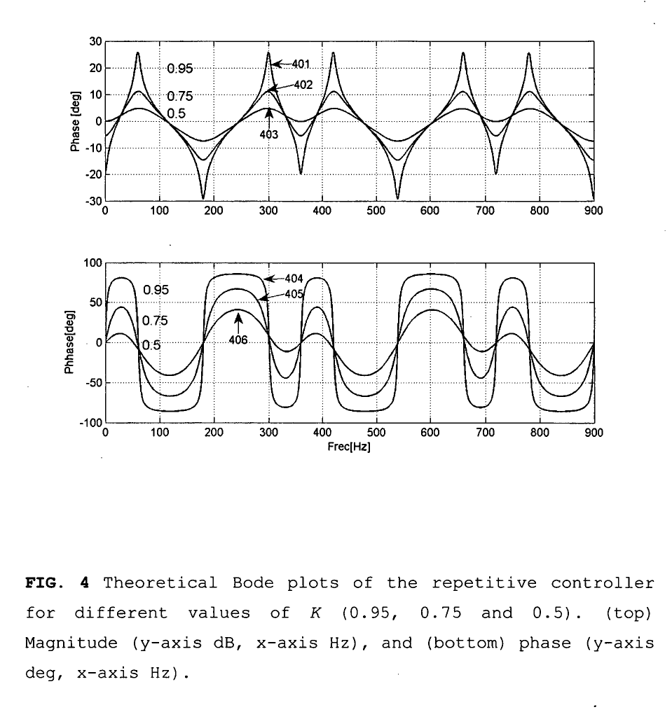

The addition of LPFs restricts the bandwidth of the controller while simultaneously reinforces the stability when the controller is installed in the closed-loop system. However, it may produce some slight inaccuracies. Summarizing, as a consequence of all these modifications, i.e., introduction of gains K and LPFs, two side effects appear: first, resonant peaks and notches are slightly shifted with respect to the corresponding harmonic frequency, and second, an almost imperceptible phase shift appears at the tuned harmonic frequencies. FIG. 4 shows the theoretical Bode plots of \tilde{G}(s) for the compensation of harmonics of 60 Hz and for several values of K. In this case, the delay time is fixed to τ_{d}=2.77 ms. For K=0.95, the plot 401 goes from 25.8 dB at the resonant frequencies to −20 dB or −29.3 dB at the notches. However, if the gain is reduced to K=0.75, the corresponding maximum magnitude for the plot 402 is 11 dB and for the minimums −5.38 dB or −14.5 dB. A further reduction to K=0.5 results in maximum and minimum magnitudes for the plot 403 of 5 dB and −7.35 dB, respectively. These plots show clearly that, as gain K decreases, the peak amplitude is reduced while the bandwidth of each peak increases, thus increasing its robustness with respect to frequency variations. It can be observed form the phase plots 404, 405, 406, that the phase shift is not zero at the resonance peaks (due to the effect of gain K in the transfer function), although the phase shift is zero at notches. Plots are bounded by 90 and −90 degrees.

A digital implementation of the proposed controller has been performed in the laboratory for experimental test using a commercial digital signal processor (DSP) based card with a sampling rate fixed to f_{S}=80 kHz. In fact, the algorithm takes around 11 μs of the 12.5 μs available. In this case, the discretization of the delay line is a simple task, and it is enough to guarantee a relatively large memory stack where data could be stored to be released after a time delay. The time delays have been fixed to

$${τ}_{d} = \frac{π}{3 {ω}_{o}} = \frac{1}{6 {f}_{o}} = \frac{1}{360} = 2.77$$

ms to deal with the 6l±1 (l=0,1,2, . . . ,∞) harmonics of fₒ=60 Hz. A discrete pure delay of the form z^{-d} has been used to implement the delay line in the repetitive scheme. Therefore, a space of d=222 memory locations (16 bits each) has been reserved to produce the required delay time, i.e., 222/80000=2.77 ms for a sampling frequency of 80 kHz.

In many power electronics applications, compensation of 6l±1 (l=0,1,2, . . . ,∞) harmonics for 50 Hz and 60 Hz are required. As a result, delays ranging from τ_{d}=2.77 ms to τ_{d}=3.33 ms should be implemented. For the experimental tests presented here, the compensation of harmonics of 60 Hz has been chosen. Therefore, a delay of τ_{d}=2.77 ms is implemented for the proposed controller. The proposed repetitive scheme can also have an analog implementation where the delay lines could be implemented with special purpose integrated circuits such as the bucket brigade delay (BBD) circuits, which were thoroughly used in the music industry for reverberation and echo effects.

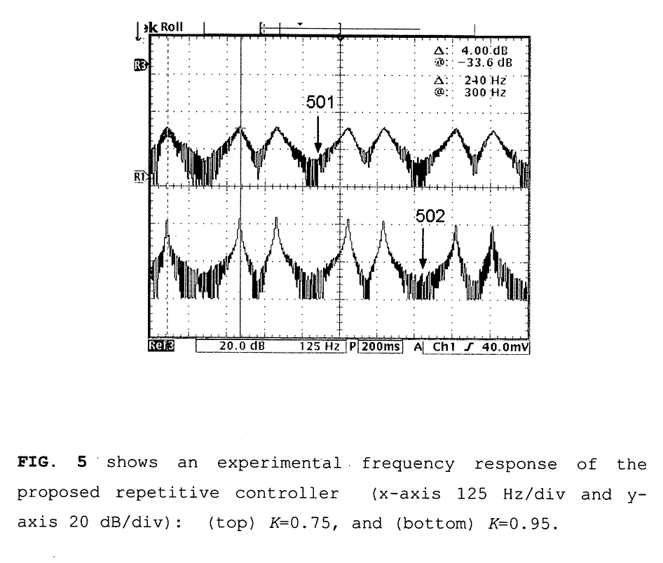

The experimental frequency response of output y(t), for the proposed compensator, is shown in FIG. 5 for K=0.75 501 and K=0.95 502. The plots show that the implemented compensator contains peaks centered at the expected values, i.e., harmonics 6l±1 (l=0,1,2, . . . ,∞) of 60 Hz.

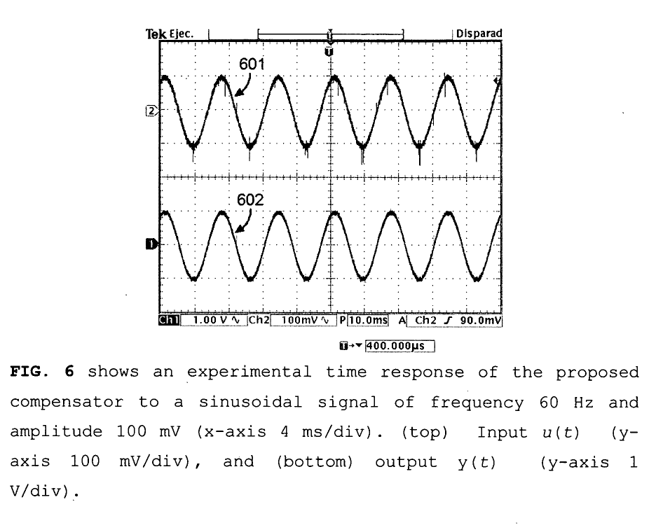

FIG. 6 shows the time responses to an input sinusoidal signal with 100 mV of amplitude and 60 Hz of frequency. The figure shows, from top to bottom, the input signal u(t) 601 and the output response y(t) 602. It can be observed that the output y(t) with feedforward compensation reaches amplitude of 950 mV, which corresponds to 19.55 dB of gain. Notice that, these values are very close to those obtained theoretically.

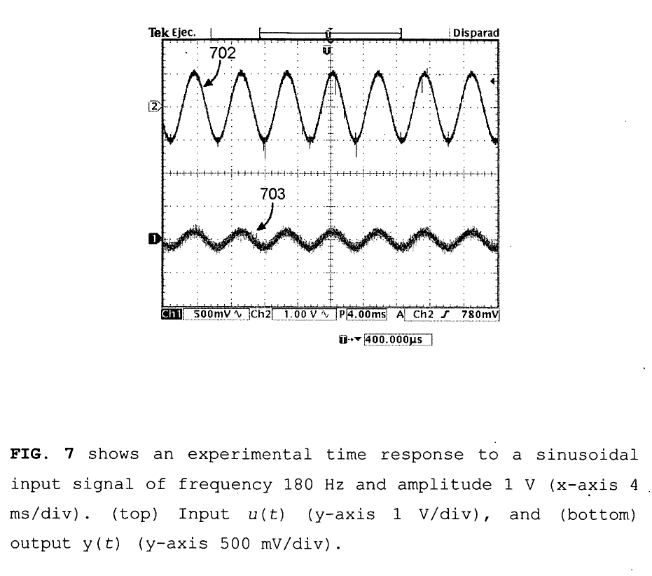

FIG. 7 shows the responses to an input sinusoidal signal with amplitude 1 V and frequency 180 Hz, that is, a signal composed of a third harmonic component, which coincides with the frequency of the notch located between peaks of 60 Hz and 300 Hz. The figure shows, from top to bottom, the responses of the input u(t) 701, and the output y(t) 702. In this plot, the scale of the output signal has been reduced to show the final shape of this signal.

1. A repetitive controller scheme comprising:
a negative feedback;
a positive feedback; and
a feedforward,
wherein the feedforward considerably improves a frequency response and performance providing higher gains with an enhanced selectivity.

2. The repetitive controller of claim 1, wherein a time delay of the controller is implemented in an analog form.

3. The repetitive controller of claim 1, wherein a time delay of the controller is implemented in a digital form.

4. The repetitive controller of claim 1, wherein the controller has the transfer function given by:
$$G ( s ) = \frac{Y ( s )}{U ( s )} = \frac{1 - {e}^{\frac{2 s π}{3 {ω}_{o}}}}{1 + {e}^{- \frac{2 s π}{3 {ω}_{o}}} - {e}^{- \frac{s π}{3 {ω}_{o}}}}$$
wherein:
Y(s) is an output,
U(s) is an input, and
ωₒ, represents the fundamental frequency of the periodic signal under compensation where the corresponding time delays are given by τ_{d}=π/(3ωₒ)=1/(6fₒ).

5. The controller of claim 1, wherein due to delay lines, the controller has a transfer function with an infinite number of poles on the imaginary axis at ω=(6l±1)ωₒ for every l=0,1,2, . . . ,∞ and an infinite number of zeros located at ω=3lωₒ for every l=0,1,2, . . . ,∞.

6. The repetitive controller of claim 1, wherein the controller includes harmonic oscillators tuned at 6l±1 (l=0,1,2, . . . ,∞) harmonics of the fundamental frequency ωₒ, that is, for G(s) the first pole lies at ωₒ and the rest of the poles lie at 6l±1 (l=0,1,2, . . . ,∞) and each zero of G(s) lies in 3lωₒ (l=0,1,2, . . . ,∞) between two consecutive poles.

7. The repetitive controller given of claim 1, wherein the controller has an expected Bode plot which consist in a set of peaks centered at the (6l±1)ωₒ (l=0,1,2, . . . ,∞) harmonic frequencies; and due to the presence of the zeros, notches appear in the middle points between two consecutive peaks, such that gain at the resonant frequencies is, effectively, infinite at the peaks and zero at the notches.

8. The repetitive controller of claim 7, wherein damping is added to all the poles/zeros by slightly shifting them to the left of the imaginary axis, such that the peak amplitude becomes bounded and, in effect, a gain factor of K is applied.

9. The repetitive controller of claim 8, wherein, the resonant peaks, originally of infinite magnitude, reach a maximum magnitude of
$$\sqrt{\frac{6 {K}^{2} + 2 \sqrt{3} \sqrt{1 + {K}^{4} + {K}^{8}}}{3 {( - 1 + {K}^{2} )}^{2}}} ,$$
while the notches reach minimum magnitudes of
$$\frac{1 - {K}^{2}}{1 + K + {K}^{2}} and \frac{1 - {K}^{2}}{1 - K + {K}^{2}} for 0.1413 < K < 1 …$$

10. The repetitive controller in claim 8, wherein the controller includes a simple low pass filter (LPF) that restricts the bandwidth of the controller and, at the same time, reinforces stability when the controller is inserted in the closed-loop system.
